(19) United States
(12) Patent Application Publication
(10) Pub. No.: US 2005/0268761 A1
(43) Pub. Date: Dec. 8, 2005

(54) Die press with removable cartridge roller

(75) Inventors: Kevin L. Corcoran, Mission Viejo, CA (US); Trevor Freeman, Costa Mesa, CA (US); Amos E. Avery, Rochester, MN (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ellison Educational Equipment, Inc., Lake Forest, CA (US)

(21) Appl. No.: 11/127,528

(22) Filed: May 11, 2005

Related U.S. Application Data
(60) Provisional application No. 60/570,164, filed on May 11, 2004.

(51) Int. Cl. B26D 1/00

(52) U.S. Cl. 83/13

(57) ABSTRACT

A portable roller press having removable cartridge rollers provides for reconfiguration through exchange of the cartridge. The die press housing includes a shell having an opening configured to receive a cartridge having one or more rollers, which may be configured to provide a desired operation. The housing can include a handle that is configured to couple with a connector on the cartridge to transfer rotational forces to the cartridge rollers. The housing can also include a base having a surface substantially aligned with a working area of the cartridge when it is inserted into the housing. One or more extendable surfaces can be coupled to the housing at the base and can be extended to increase the surface of the base. The extendable surfaces can each have one or more feet on the underside to support the housing.

### CROSS-REFERENCES TO RELATED APPLICATIONS

This application claims the benefit of U.S. Provisional Application No. 60/570,164, filed May 11, 2004, entitled DIE PRESS WITH REMOVABLE CARTRIDGE ROLLER; which is hereby incorporated herein by reference in its entirety.

### FIELD OF THE DISCLOSURE

The present disclosure relates to a roller cutting press and, more particularly, a roller press with a removable cartridge.

### BACKGROUND OF THE DISCLOSURE

Dies and sheet cutting presses are used to cut various patterns out of sheet materials. The presses are designed to apply uniform pressure to a die through a series of rollers to cut through a sheet or a plurality of sheets simultaneously. The resulting shapes are a result of the die that is inserted into the rollers in the roller press which applies pressure to the die and the material to be cut from. The rollers may have predetermined shapes, textures, or forms to allow the press to emboss, texture, or form the worked material.

### BRIEF SUMMARY OF THE DISCLOSURE

A portable roller press having removable cartridge rollers provides for reconfiguration through exchange of the cartridge. The die press housing includes a shell having an opening configured to receive a cartridge having one or more rollers, which may be configured to provide a desired operation. The housing can include a handle that is configured to couple with a connector one the cartridge to transfer rotational forces to the cartridge rollers. The housing can also include a base having a surface substantially aligned with a working area of the cartridge when it is inserted into the housing. One or more extendable surfaces can be coupled to the housing at the base and can be extended to increase the surface of the base. The extendable surfaces can each have one or more feet on the underside to support the housing.

The disclosure includes a die press that includes a shell having a shell opening and a cartridge having at least one roller and configured to be releasably coupled to the shell when inserted into the shell opening.

An embodiment of the disclosure also includes a die press housing that includes a shell having a shell opening configured to receive a cartridge having at least one roller, and a cartridge latch mechanism coupled to the shell and configured to retain the cartridge when the cartridge is inserted into the shell by at least a predetermined distance.

An embodiment of the disclosure includes a removable cartridge for a die press. The cartridge includes a first roller configured to receive a rotational force when the cartridge is inserted into a die press housing, and a second roller coupled to the first roller and configured to rotate in an opposite direction of the first roller.

An embodiment of the disclosure includes a method of operating a die press. The method includes providing a die press housing having a cartridge opening, selecting a cartridge for coupling with the die press housing, the cartridge having at least one roller, inserting the cartridge into the cartridge opening to engage the cartridge with the die press housing, and providing a rotational force to a portion coupled to the die press housing to transfer a corresponding rotational force to the at least one roller.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 illustrates an embodiment of a die press with removable cartridge.

FIG. 2 illustrates a side view of an embodiment of a die press with removable cartridge.

FIG. 3 illustrates an end view of an embodiment of a die press with removable cartridge.

FIG. 4 illustrates a top view of an embodiment of a die press with removable cartridge.

FIG. 5 illustrates an end view of an embodiment of a die press with removable cartridge.

FIG. 6 is a bottom view of an embodiment of a die press with removable cartridge.

FIG. 7 illustrates a perspective view of an embodiment of a cover for the die press.

FIG. 8 illustrates a side view of an embodiment of a cover for the die press.

FIG. 9 illustrates a back view of an embodiment of a cover for the die press.

FIG. 10 illustrates a top view of an embodiment of a cover for the die press.

FIG. 11 illustrates a bottom view of an embodiment of a cover for the die press.

FIG. 12 illustrates an inside perspective view of an embodiment of a cover for the die press.

FIG. 13 illustrates a detailed view of an embodiment of a cartridge latch mechanism.

FIG. 14 illustrates a perspective view of an embodiment of a cartridge latch mechanism.

FIG. 15 illustrates a top view of an embodiment of a cartridge latch mechanism.

FIG. 16 illustrates a bottom view of an embodiment of a cartridge latch mechanism.

FIG. 17 illustrates a perspective view of an embodiment of a release button.

FIG. 18 illustrates views of an embodiment of a release button.

FIG. 19 illustrates additional views of an embodiment of a release button.

FIG. 20 illustrates a perspective view of an embodiment of a shell assembly.

FIG. 21 illustrates an end view of an embodiment of a shell assembly.

FIG. 22 illustrates a side view of an embodiment of a shell assembly.

FIG. 23 illustrates a top view of an embodiment of a shell assembly.

FIG. 24 illustrates a bottom view of an embodiment of a shell assembly.

FIG. 25 illustrates an embodiment of a bottom shell.

FIG. 26 illustrates an embodiment of a crank handle.

FIG. 27 illustrates a detailed view of an embodiment of a crank handle and cartridge.

FIG. 27A illustrates a schematic diagram illustrating an embodiment of rotation of the rollers within a cartridge.

FIG. 28 illustrates an embodiment of a gear assembly within a cartridge.

FIG. 29 illustrates an embodiment of a first cartridge frame portion.

FIG. 30 illustrates an embodiment of a gear assembly within a cartridge.

FIG. 31 illustrates an embodiment of an insert for use with a cartridge.

FIG. 32 illustrates a close up view of an embodiment of a tab on an insert.

FIG. 33 illustrates a detailed view of an embodiment of an extendable surface.

FIG. 34 illustrates a detailed view of an embodiment of an extendable surface.

FIG. 35 illustrates a detailed view of an embodiment of an extendable surface detached from a base portion.

FIG. 36 illustrates an embodiment of a gear assembly on a cartridge.

FIG. 37 illustrates an embodiment of a gear assembly on a cartridge.

FIG. 38 illustrates a perspective view of an embodiment of the die press with a die.

FIG. 39 illustrates a side view of an embodiment of the die press with a die.

FIG. 40 illustrates an end view of an embodiment of the die press with a die.

### DETAILED DESCRIPTION OF THE DISCLOSURE

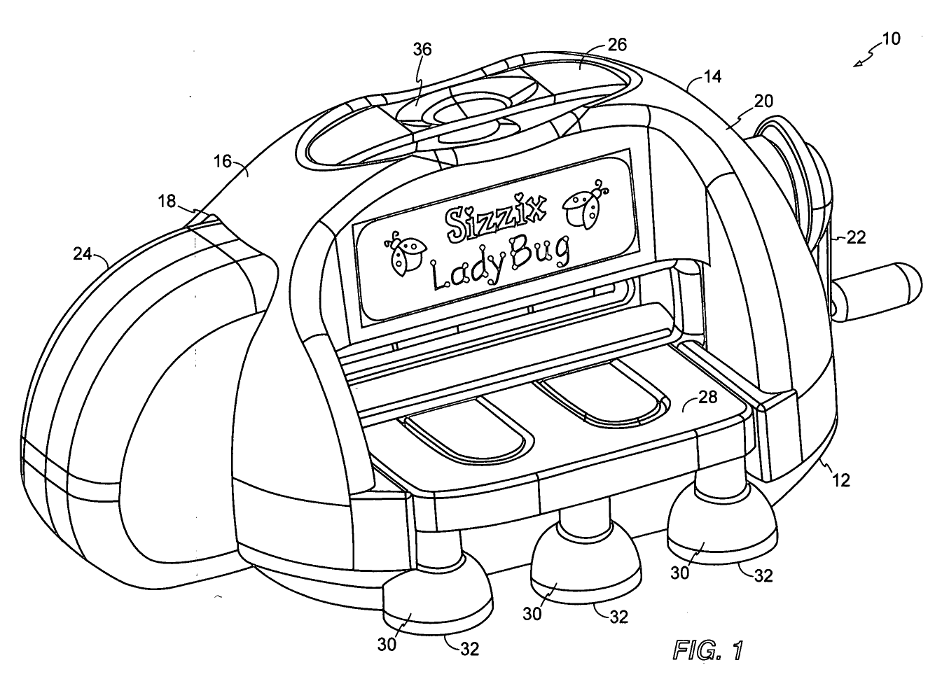

A die press includes a base 12 and connected to the base is a shell 14 with the shell having an first side 16 with a first opening 18. The shell 14 also has a second side 20 with a crank handle 22 located at the second side 20. At the first side 16 and located through the opening 18 is a roller cartridge 24. A cartridge 24 shown in FIG. 1 illustrates a cartridge utilizing rollers. The cartridge 24 is also removable and different cartridges may be inserted into the press 10 with cartridges that have different functions. For example, the different cartridge may include opposing rollers with a male pattern on one roller and a female pattern on the other roller so as to emboss the sheet material as it passes in between the two rollers. In addition, a variety of cartridges 24 may be utilized in the die press of the present disclosure. As by way of example, another cartridge may include two rollers that pinch or crimp the sheet material according to patterns on the rollers. In addition, another cartridge may be used to texture or score patterns onto a portion or the entire sheet as it is passed through the rollers.

The crank handle 22 is removably coupled to the cartridge 24 so that when the crank handle 22 is rotated the rollers, or other components located in the cartridge, such as the crimpers, rotate as will be further explained below.

The shell 14 further includes a top recessible handle 26 so that the press 10 may be easily carried and moved from one location to another.

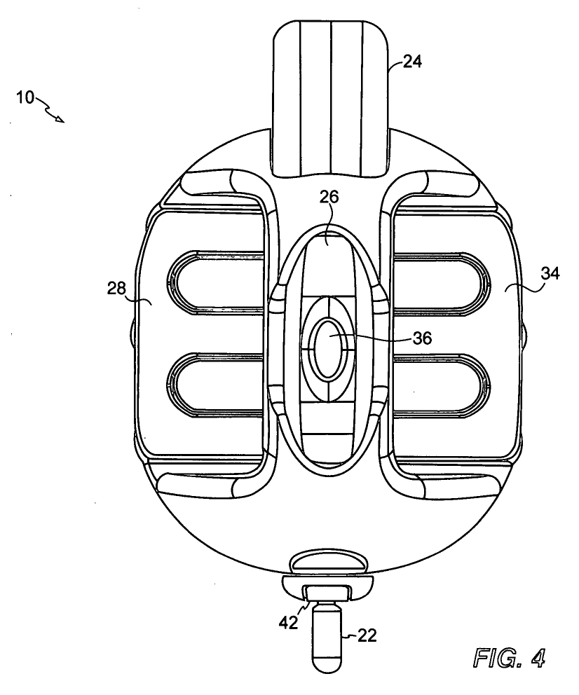

The base portion 12 further includes an extendable working surface 28 which includes interfitting sections that interfit with the base 12. Extending from the bottom of the extendable surface 28 is a plurality of feet 30 with a rubber footpad 32 for providing a non-slip surface of the press when it is resting on a table top or otherwise flat surface. A second extendable surface is located on the opposite side of the press and as best shown in FIG. 4.

In addition, as will be further explained below, the handle 26 is made of a resilient or flexible material and includes a recessed portion of the handle 36 so that the cartridge 24 may be released from the press 10.

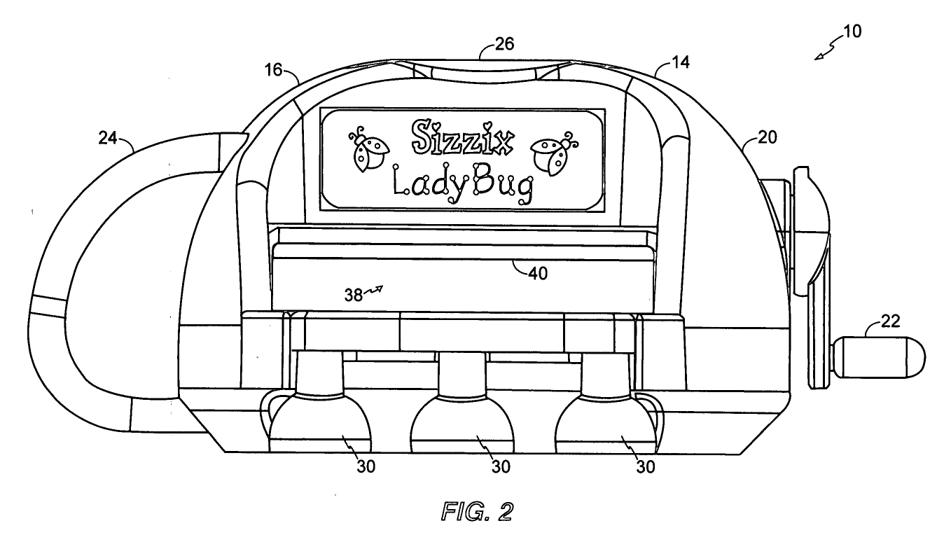

As shown in FIG. 2, the press 10 includes a working area 38 to accommodate a die and shuttle, or cutting pad. Also as shown in FIG. 2, since the cartridge 24 shown is a roller cartridge, the top roller 40 is shown at the upper portion of the working area 38.

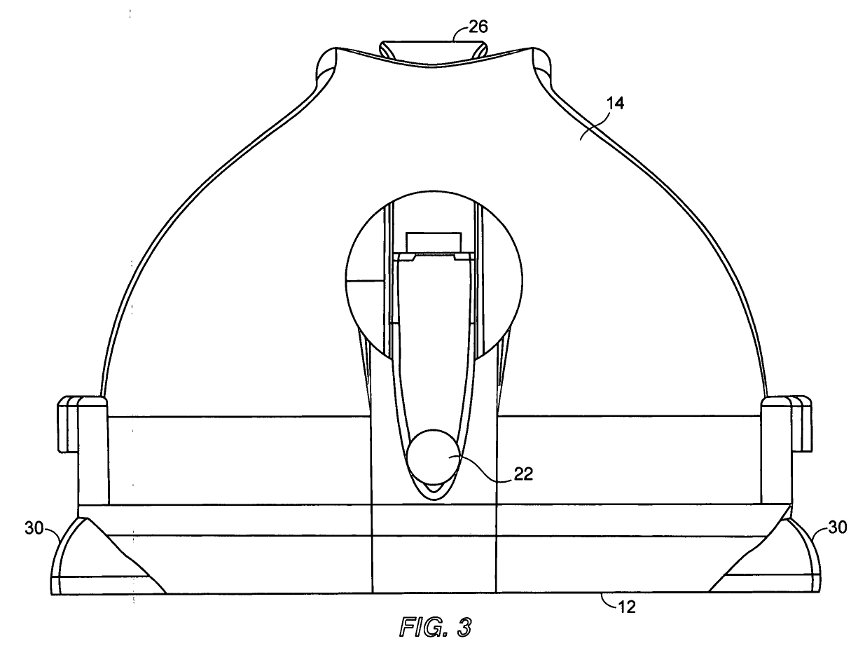

FIG. 3 illustrates a back view of the press illustrating the crank handle 22 located at the second side of the press.

FIG. 4 illustrates a top view of the press 10 with the extendable surfaces 28 and 34 shown in a collapsed position. FIG. 4 also illustrates the recessed portion 36 of the handle 26. As will be further discussed below, the user applies force to the recessed portion 36 of the handle 26 to activate a release latch to release the cartridge 24 from the shell and generally the press. The crank handle 22 has a hinge 42 so that the crank handle may be rotated 180° and stored in a configuration so that the handle is pointed inward toward the shell 14 and, therefore, taking less room when the press 10 is stored.

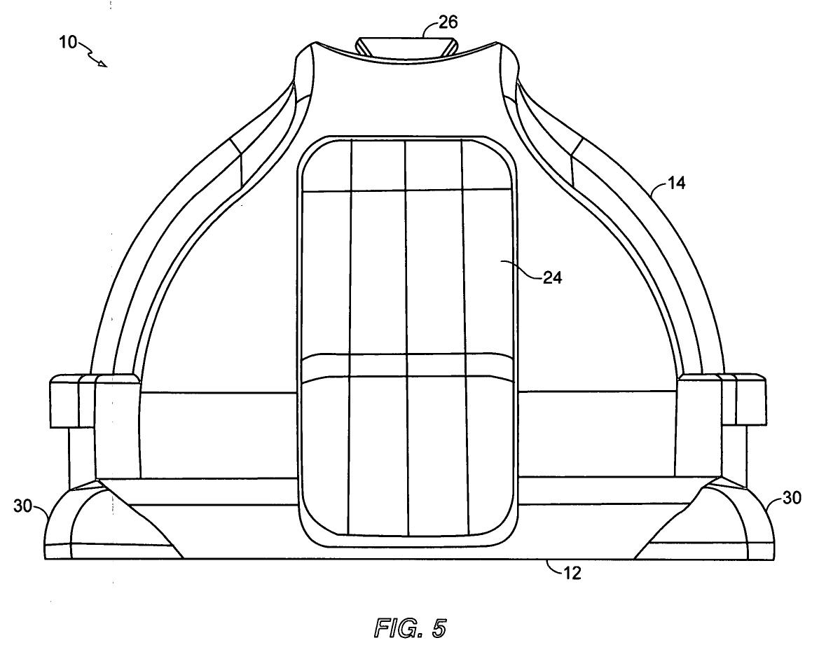

FIG. 5 illustrates a front view of the press 10 with the cartridge 24 shown in the inserted and locked position relative to the shell 14 and generally the press 10.

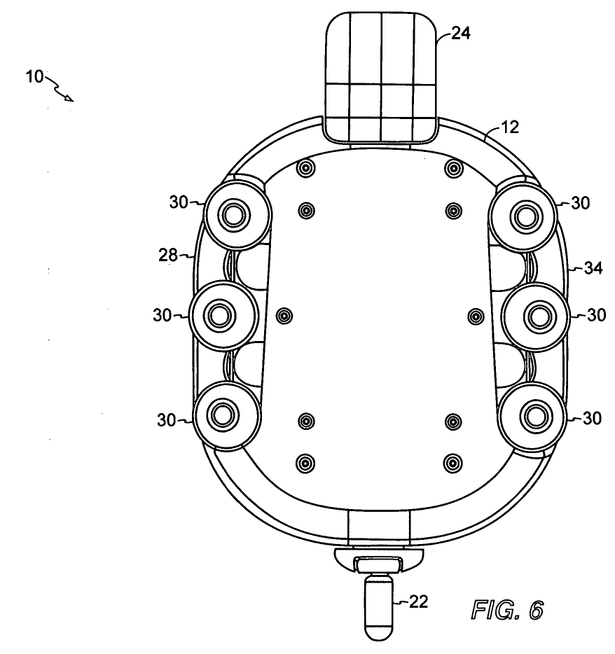

FIG. 6 illustrates the bottom view of the press 10 with the extendable surfaces 28 and 34 shown in the collapsed position.

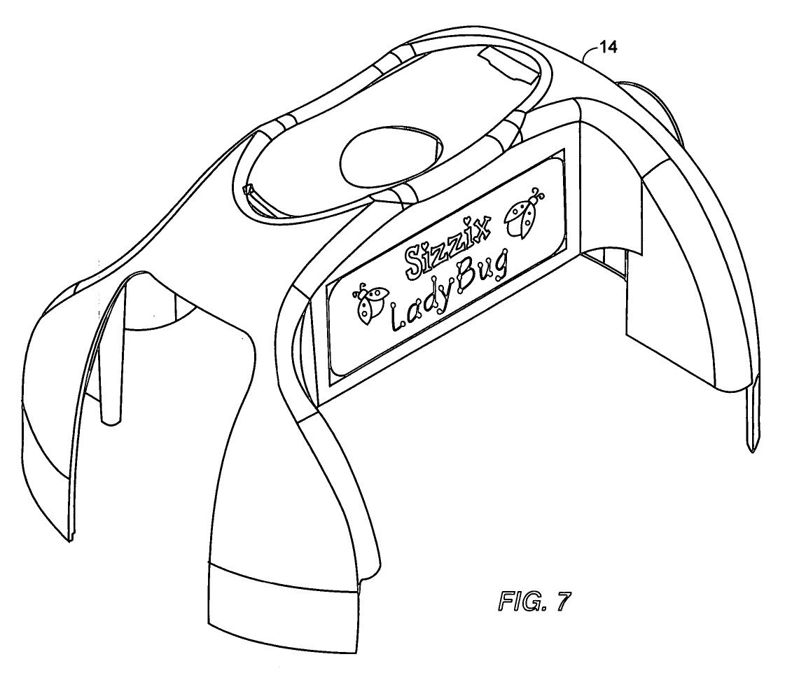

FIG. 7 illustrates a perspective view of the shell 14 shown as an individual component without the other components of the press 10.

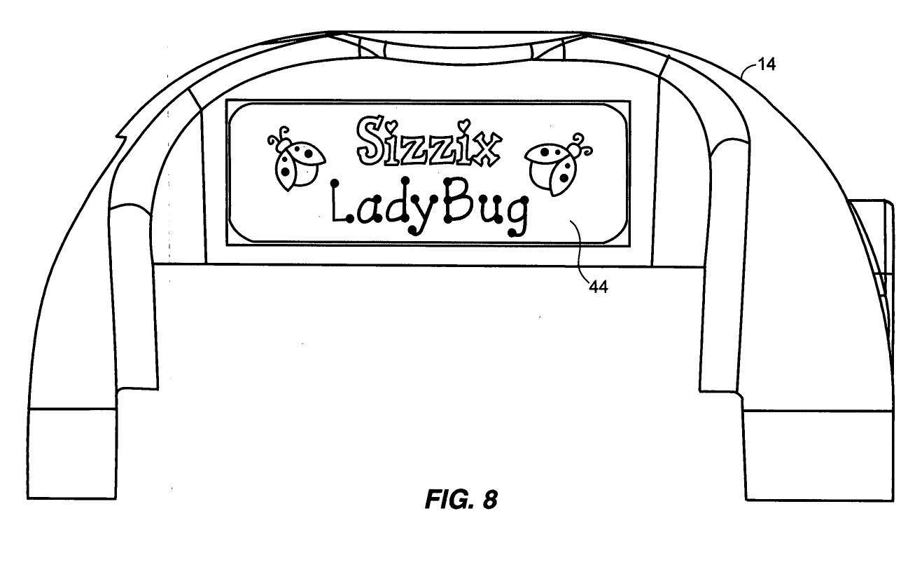

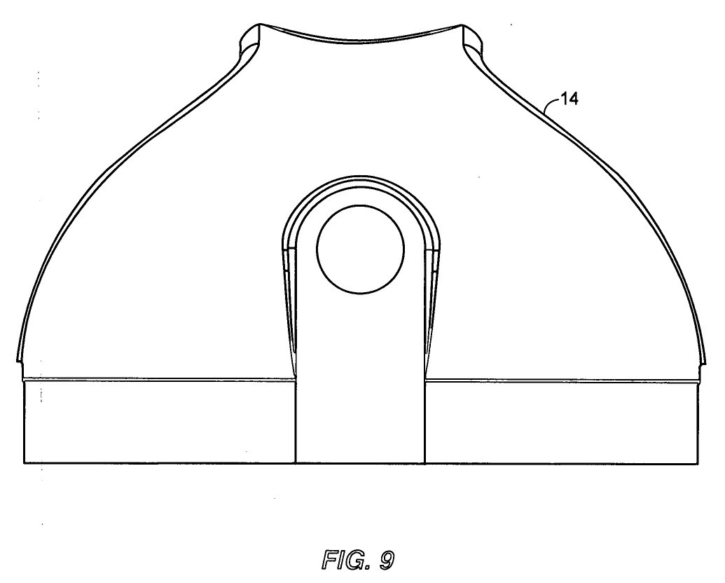

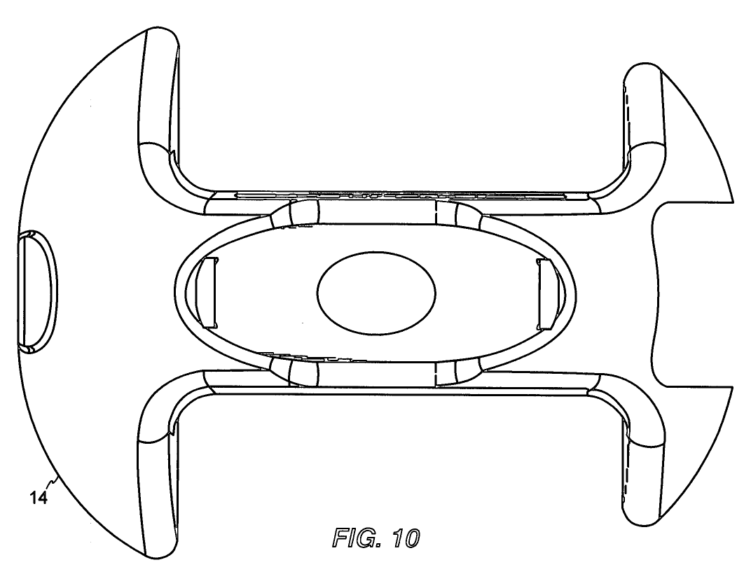

FIG. 8 illustrates a side view of the shell 14 with indicia 44 located on the side portion of the shell 14. FIG. 9 illustrates a back view of the shell 14.

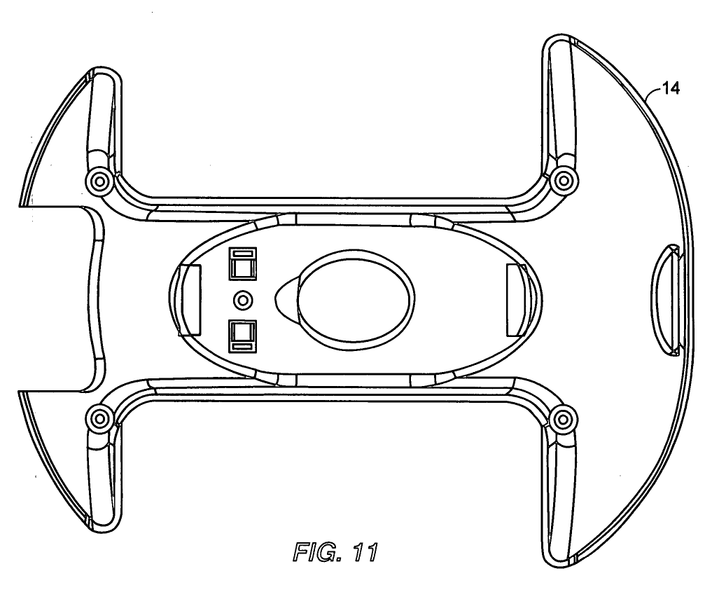

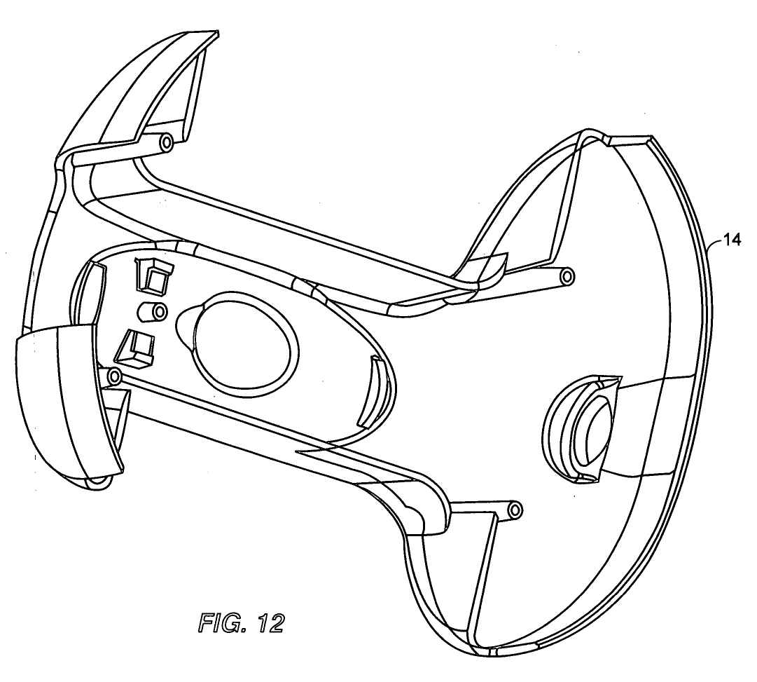

FIG. 11 illustrates a bottom view of the shell 14. FIG. 12 illustrates an inside perspective view of the shell 14.

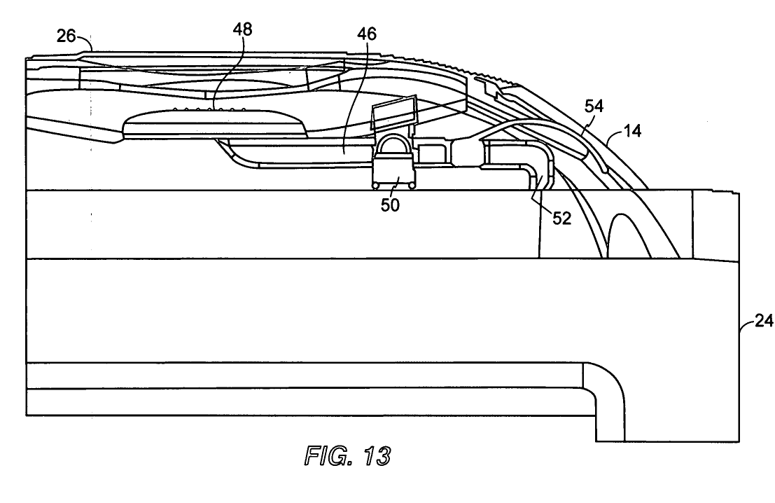

Referring to FIG. 13, shown is a cross-sectional view of the cartridge locking mechanism, otherwise known as a cartridge latch mechanism. The cartridge latch mechanism locks the cartridge 24 into the press 10. The cartridge latch mechanism is illustrated as numeral 46. The mechanism includes a button 48, a pivot point 50 and a tang 52. Tang 52 interlocks with a recess in the cartridge 24 when the cartridge 24 is fully inserted into the shell 14. When the user desires to unlock and remove the cartridge 24 from the press 10 and the shell 14, then the user applies force to the handle 26 and more particularly to the recessed portion 36 so that pressure can be applied to the button 48. When pressure is applied to the button 48, the cartridge latch mechanism 46 pivots about pivot point 50 and tang 52 is raised and disconnected from the recess in the cartridge 24. A spring at the second side 20 internal to shell 14 applies force to the cartridge 24 which slightly pushes the cartridge 24 out from the shell 14 when the tang 52 is disconnected from the recess and the cartridge 24.

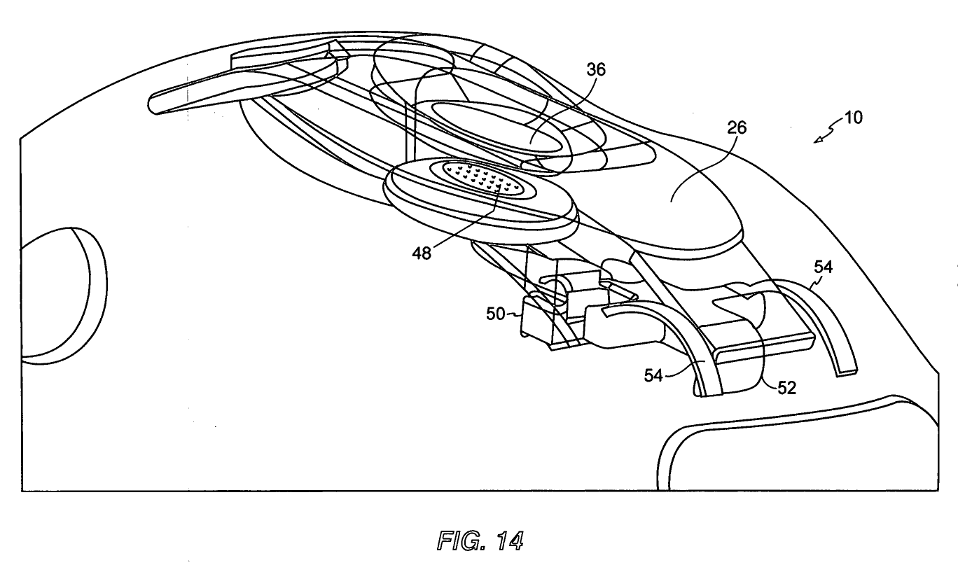

FIG. 14 illustrates a perspective phantom view of the cartridge latch mechanism and the handle. Leaf springs 54 apply pressure to tang 52 to keep the tang 52 engaged in a recess in the cartridge 24. The leaf springs 54 also allow the tang 52 to set into the recess in the cartridge 24 when the cartridge 24 is being inserted into the shell 14.

FIG. 14 illustrates a perspective phantom view of the cartridge latch mechanism of the press 10 of the present disclosure. The button 48 is located directly underneath the depressed portion 36 of the handle 26. When pressure is applied to the button 48, the latch mechanism pivots about pivot point 50 and the tang 52 retracts from a recess in the cartridge 24. Leaf springs 54 help to keep the tang 52 engaged with the recess of the cartridge 24 when the cartridge is fully inserted into the press 10.

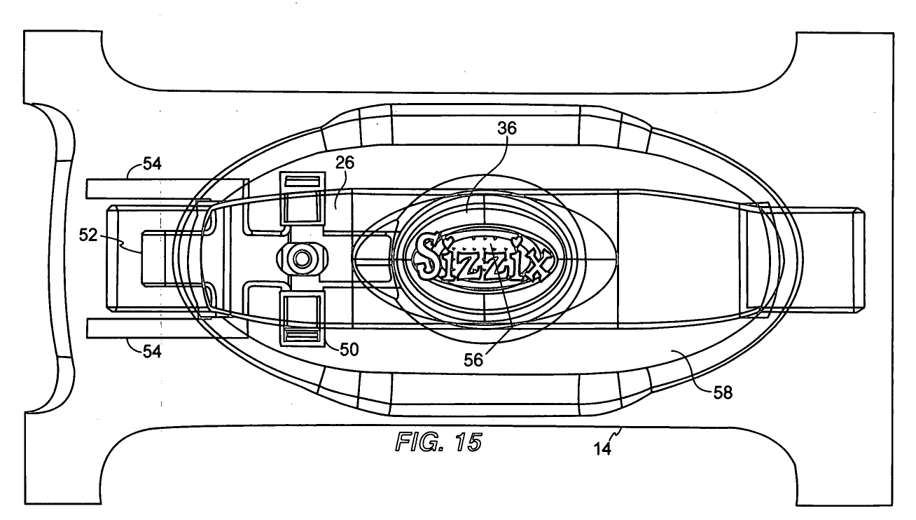

FIG. 15 illustrates a top view of the cartridge latch mechanism in the handle according to the present disclosure. Indicia 56 may be embossed or otherwise located on the handle or in the depression 36 in the handle. Also, as shown in FIG. 15, a recessed area 58 located around the handle allows for the user to easily fit the user's fingers and hand around the handle to lift and press up the handle when the press is being transported.

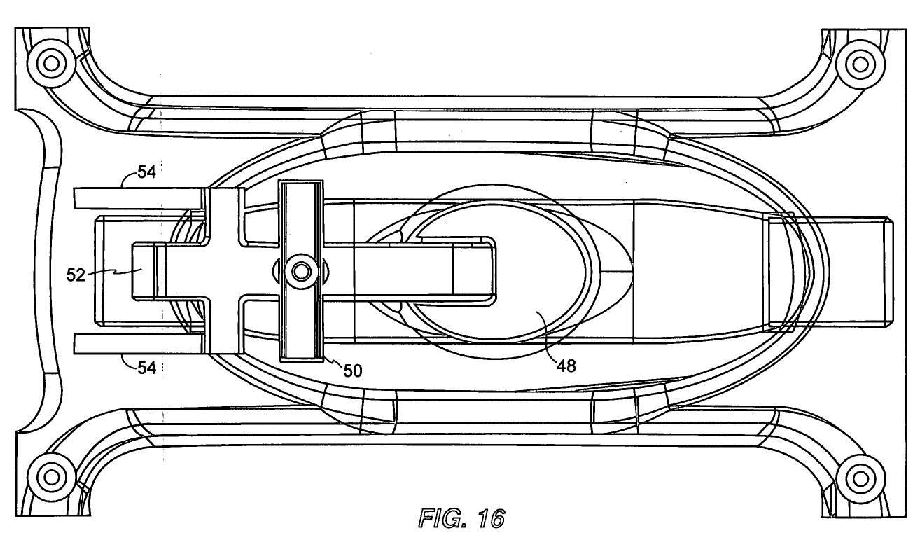

FIG. 16 illustrates a bottom view of the cartridge latch mechanism and handle according to the present disclosure.

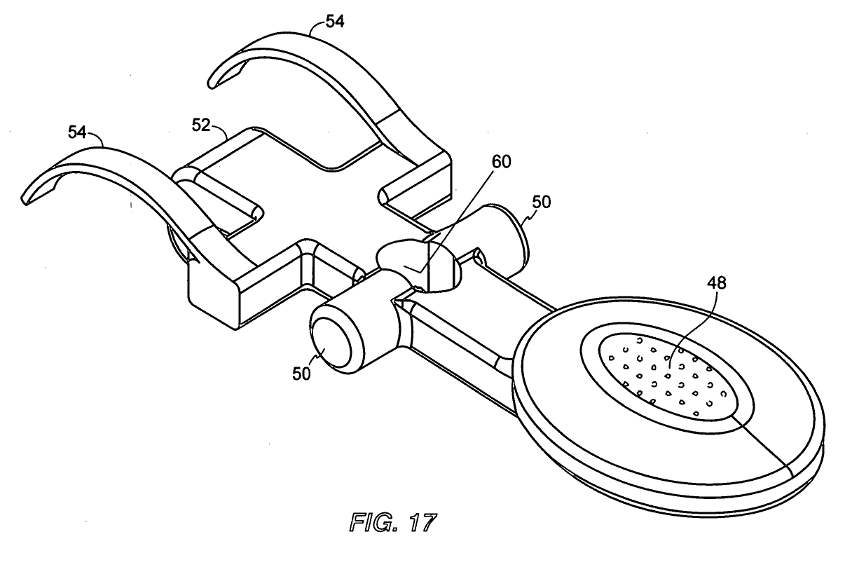

FIG. 17 illustrates a perspective view of the release button of the latch mechanism, including button 48, and pivot point 50, tang 52 and leaf springs 54. The mechanism may be secured to the press through an aperture 60.

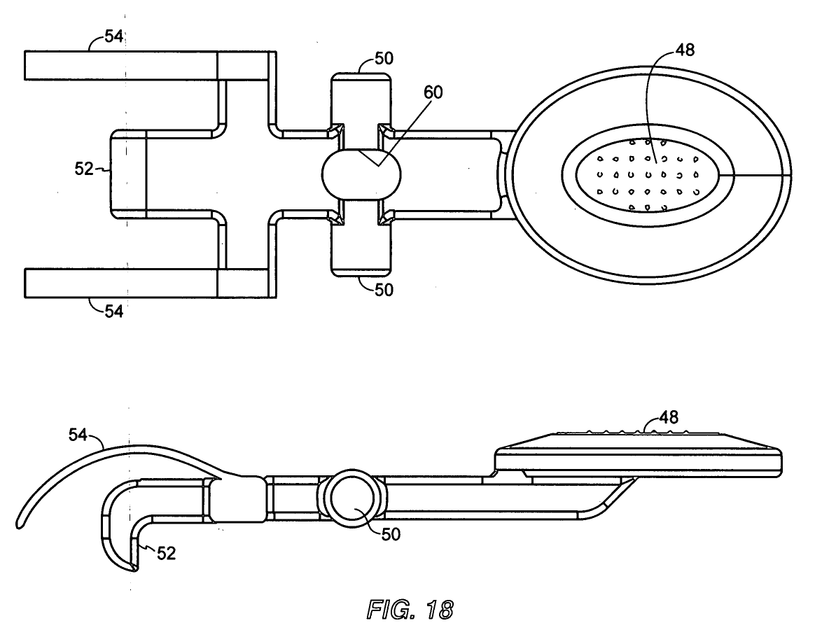

FIG. 18 illustrates a top view and side view of the release button as shown in the present disclosure.

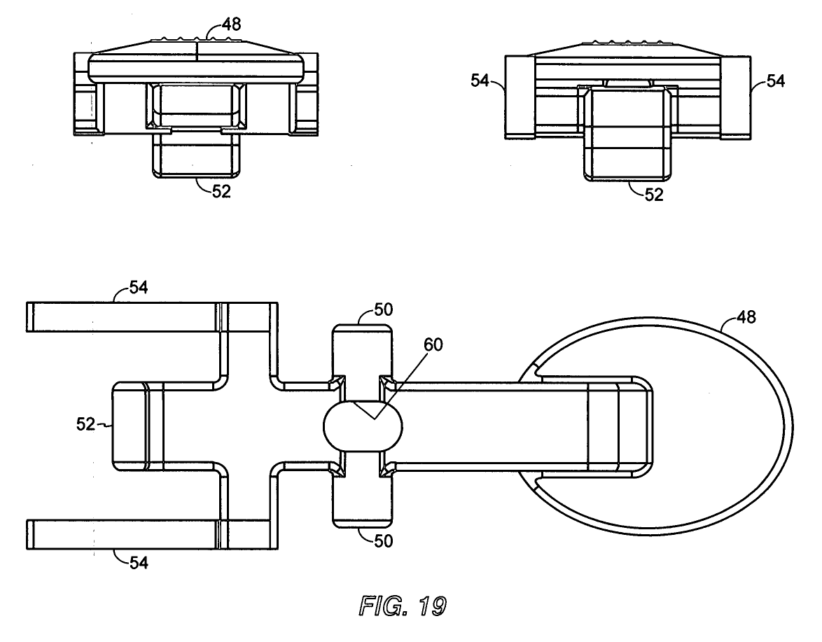

FIG. 19 illustrates front and back views, and bottom views of the release button of the latch mechanism of the present disclosure.

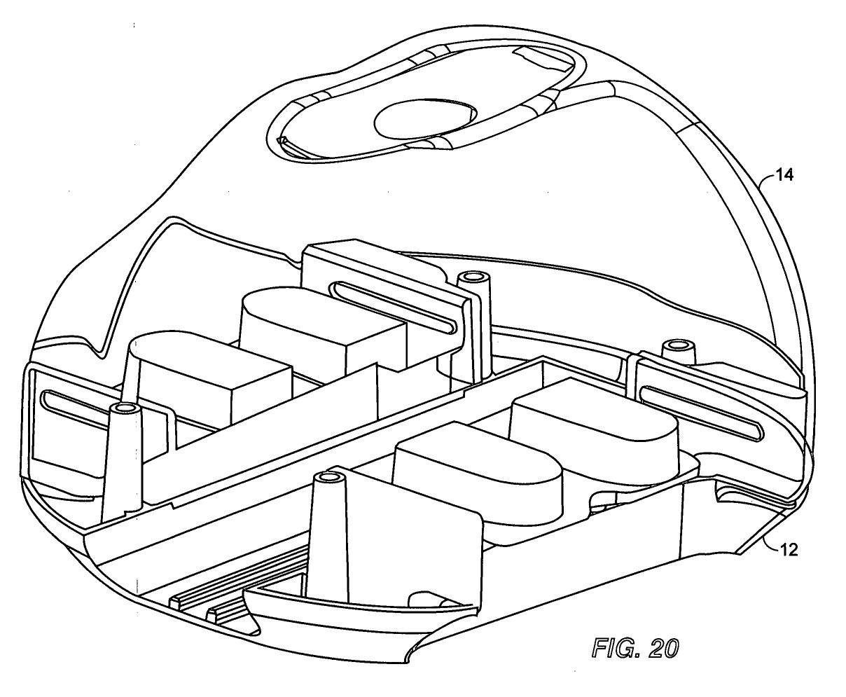

FIG. 20 illustrates a perspective phantom view of the shell assembly with the shell 14 located on top of the base 12. The extendable surfaces 28 and 34 are shown removed in FIG. 20.

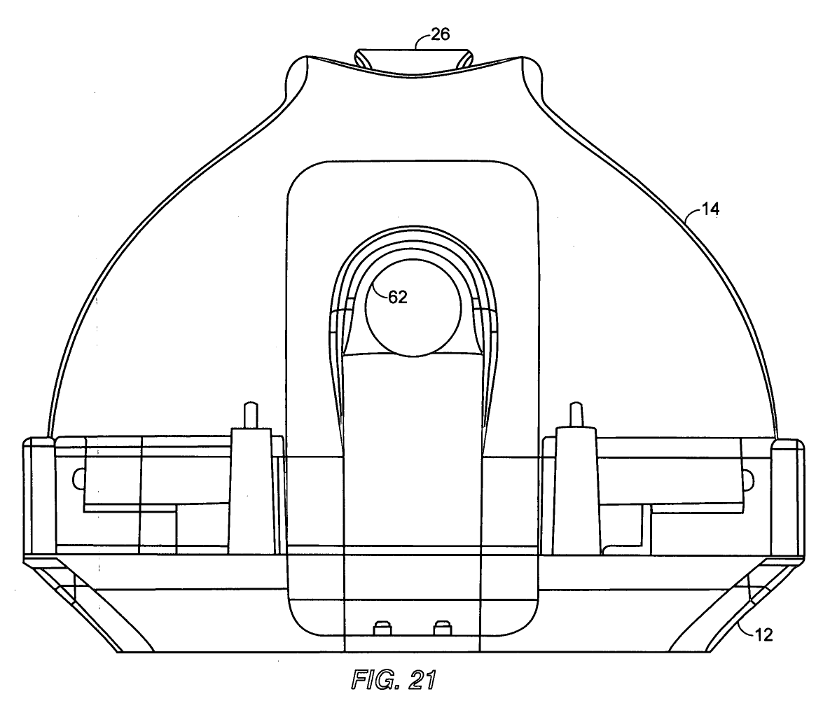

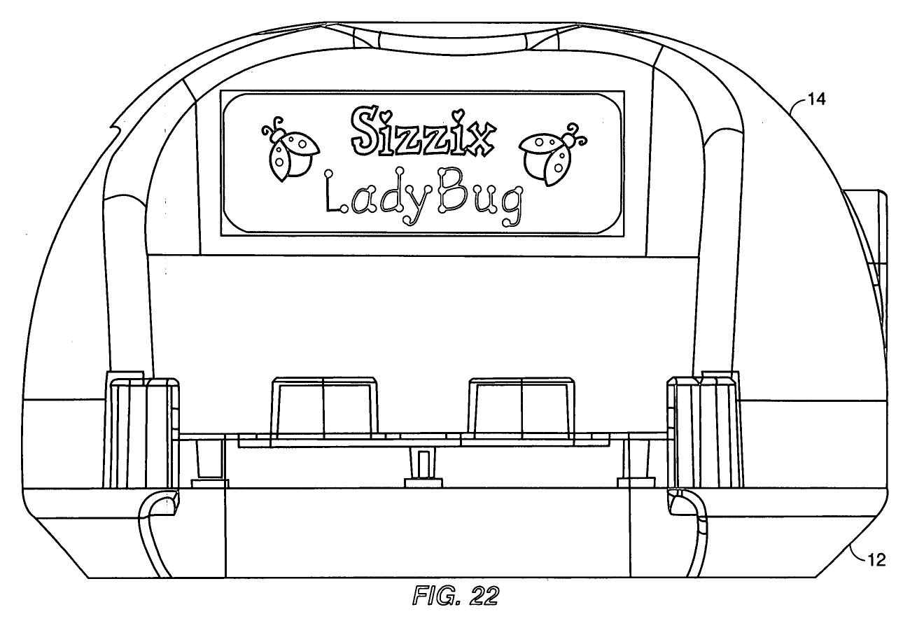

FIG. 21 illustrates a front phantom view of the shell assembly of the present disclosure, wherein the crank handle 22 is shown removed, exposing a crank handle opening 62 for acceptance of a portion of the crank handle 22, as will be further disclosed below. FIG. 22 illustrates a side phantom view of the shell assembly according to the present disclosure. The shell assembly illustrated in the figure does not include a cartridge, the crank handle, or the extendable surfaces with the feet.

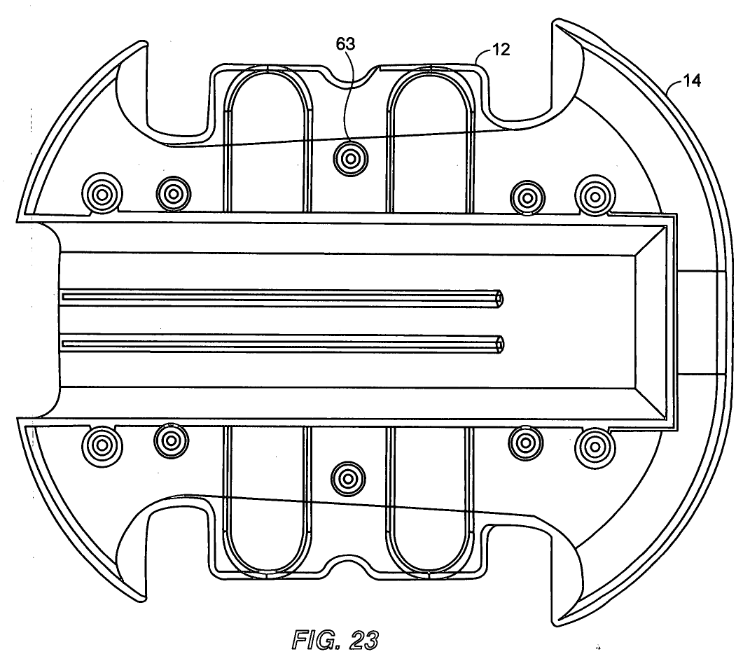

FIG. 23 illustrates a top phantom view of the shell assembly according to the present disclosure. This view illustrates the number of fasteners, such as fastener 64, which are used to fasten the shell 14 to the base 12.

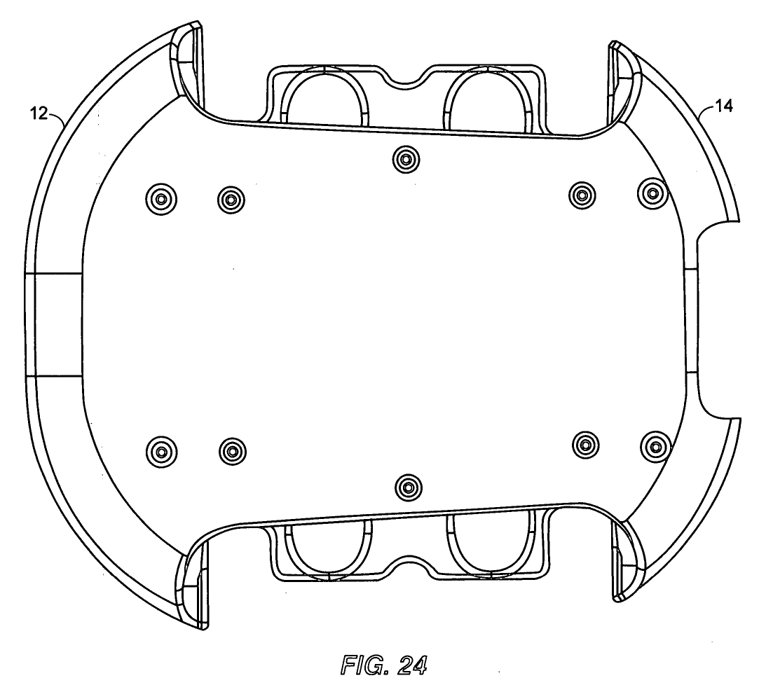

FIG. 24 illustrates a bottom view of the shell assembly according to the present disclosure.

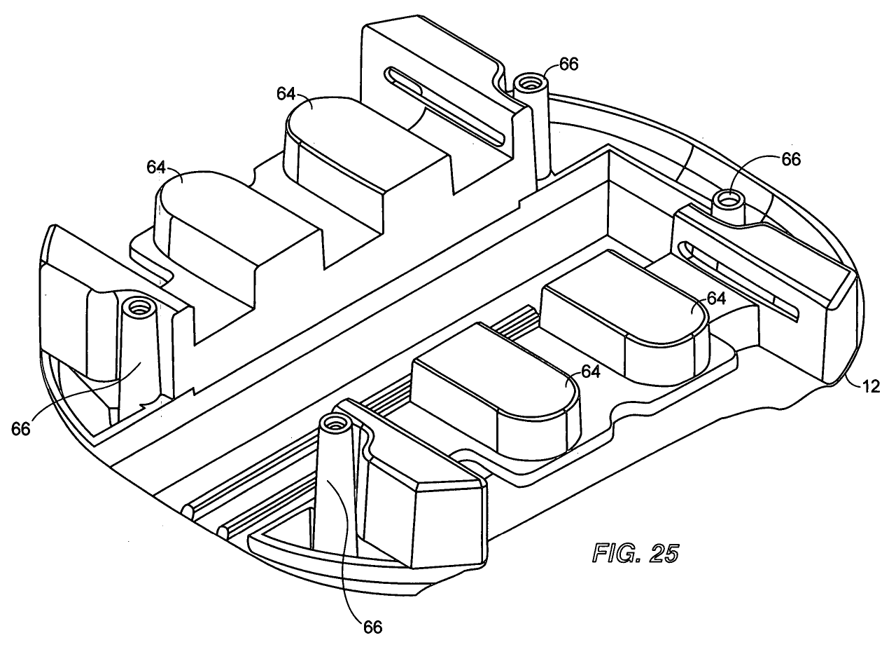

FIG. 25 illustrates a perspective view of the base portion of the press according to the present disclosure. The base 12 includes stationary surface areas 64 which cooperate with the extendable surface components 28 and 34 to provide a working surface area. The base 12 also includes risers 66 with threaded apertures so that shell 14 may be connected and secured to base 12 with a plurality of fasteners.

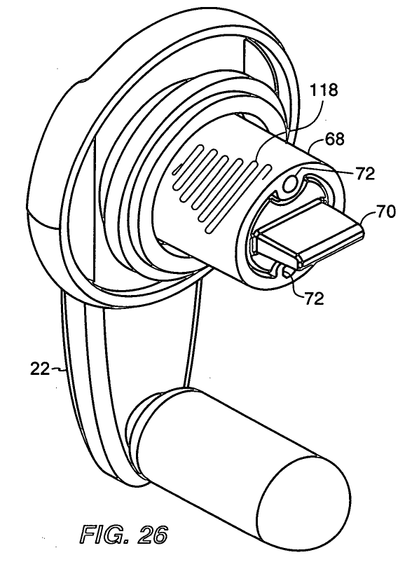

FIG. 26 illustrates a detailed view of the crank handle 22, with crank handle 22 being the folded position, that is with the handle folded back onto itself such as if the press was being stored. The crank handle 22 includes a protrusion 68 with a flat extension 70 extending beyond the protrusion 68. The flat extension 70 extends into and couples with a gear mechanism coupled to the rollers as will be further explained below. The protrusion 68 also includes connector aperture 72 so that the crank handle may be fastened to the shell 14. An internal spring 118 is located in the protrusion 68 so that the flat extension 70 has some give to it, while providing resistance so that when the cartridge 24 is positioned into the press 10 that the crank handle 22 may be properly aligned with the connector 74, by the user rotating the crank handle in a clockwise or counterclockwise position so that the flat extension 70 can mate with the connector 74.

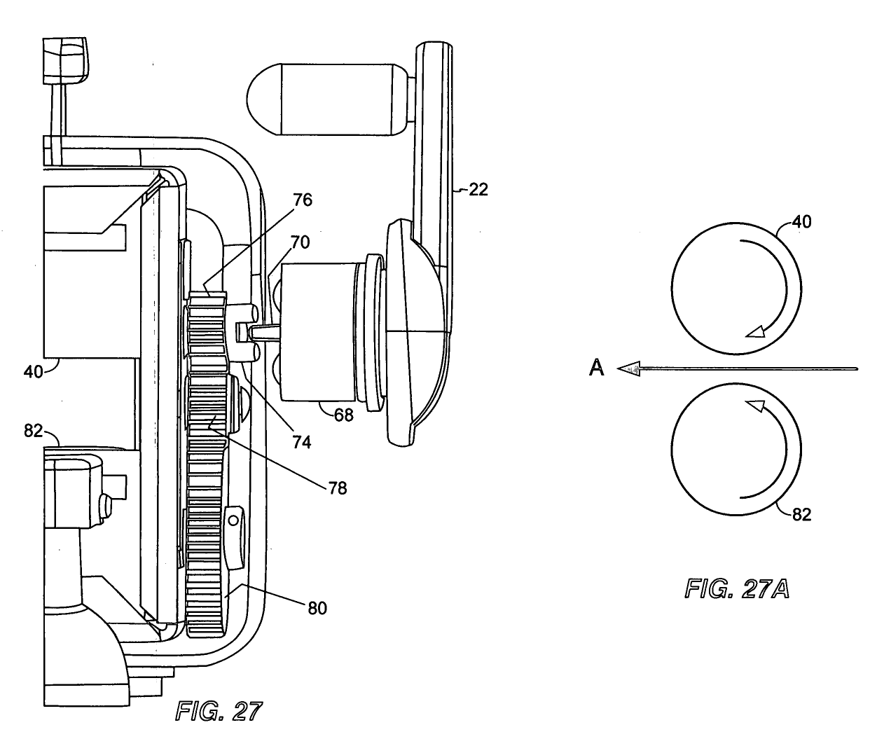

As shown in FIG. 27, the crank handle 22 is coupled to the press by the flat extension 70 of the crank handle 22 mating with a connector 74 extending from a first gear 76. The first gear 76 is engaged with and rotates a second gear 78, otherwise known as an idler gear. The idler gear 78 is connected with and rotates a third gear 80. The third gear 80 is coupled to and connected with the lower roller 82. As will be further described below, another combination of gears located at the opposite of the press cooperate to rotate the upper roller 40 in an opposite rotation direction relative to the lower roller 82. Therefore, when the crank handle 22 is rotated, the lower roller 82 rotates in a first direction, with the upper roller 40 rotating in an opposite direction so that a die, or a die with a shuttle which includes a cutting pad may be fed through the rollers with the rollers applying pressure to the die while moving the die through the rollers in a direction of the rotation of the rollers.

The rotation of the rollers is further illustrated in FIG. 27A which illustrates a schematic representation of the lower roller 82 rotating in a counterclockwise rotation, with the upper roller 40 rotating in an opposition clockwise rotation so as to provide a direction A, shown in the figure as right to left, which represents the direction of the die, or the die shuttle through the rollers 40 and 82. It will be appreciated by those skilled in the art that the rotation of the rollers may be in a clockwise or in a counterclockwise position.

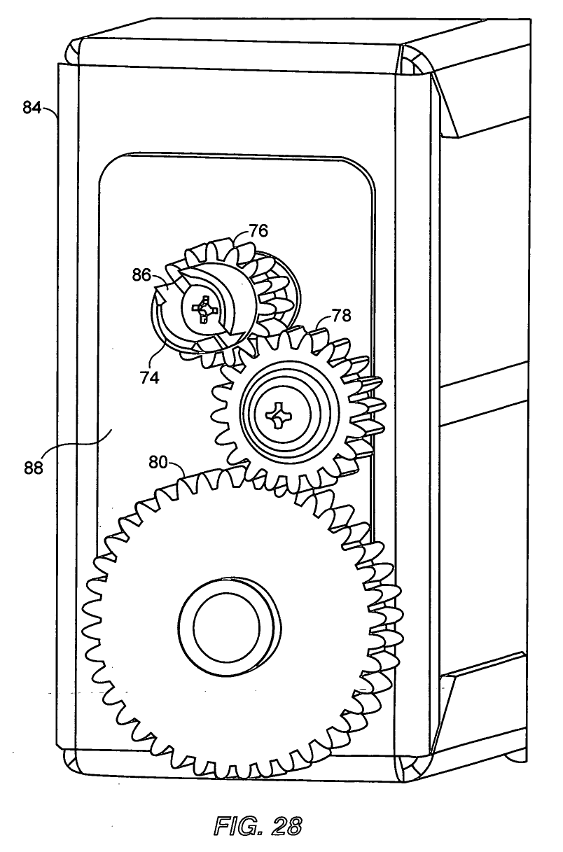

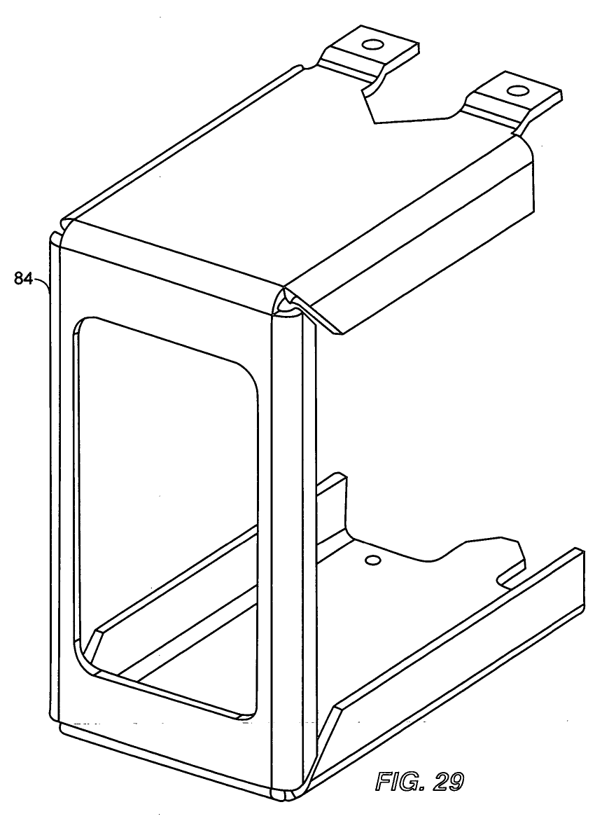

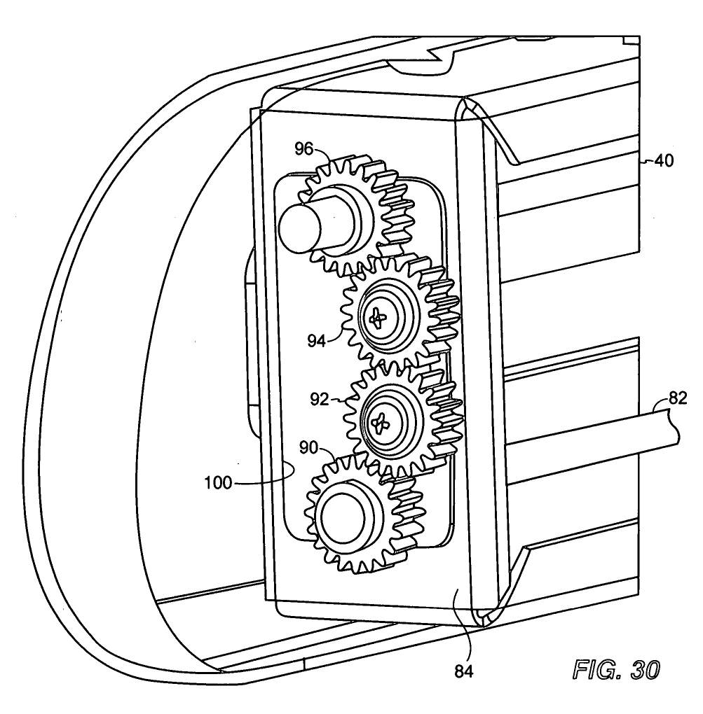

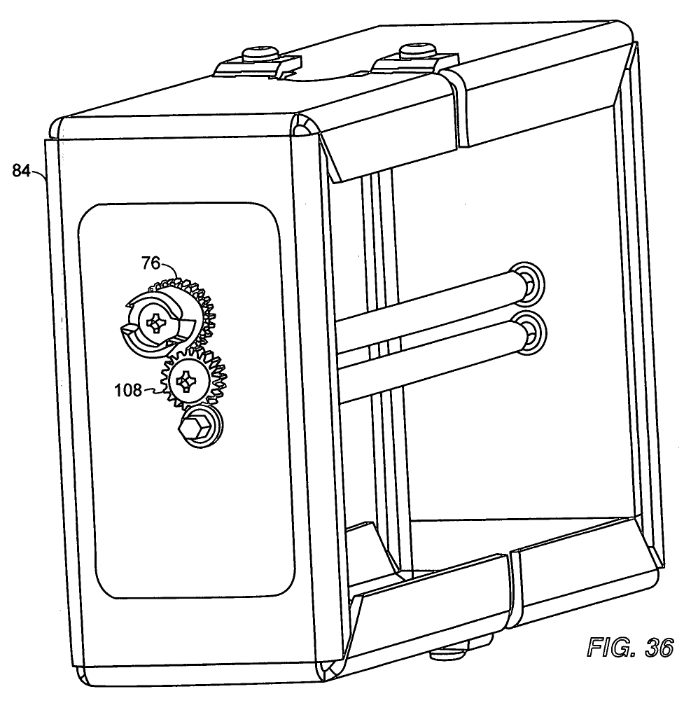

FIG. 28 illustrates a slot 86 located in the connector 74, which is an extension of the first gear 76. The first gear 76 is shown meshing with the second gear 78, which is shown meshing with the third gear 80. The gears at the crank handle end of the press are shown in FIG. 28 located on a frame 84. As will be further explained below, the gears may be supported by an insert 88 which is inserted into the frame 84. FIG. 29 illustrates a first side of frame 84. Two of the components shown in FIG. 29 may be connected so as to make opposing frame ends as shown in FIG. 36. Connectors or fasteners are utilized to secure the frame and portions together to complete the assembly of the frame. FIG. 30 illustrates an end view opposite from that shown in FIG. 28. In FIG. 30, at the end view opposite of the crank handle, the lower roller 82 is connected to a fourth gear 90 which rotates a fifth gear 92, which rotates a sixth gear 94, which rotates a seventh gear 96. The seventh gear 96 is coupled to and rotates the upper roller 40. It will be appreciated by those skilled in the art that based upon the spacing of the rollers and the size of the gears, as well as the space constraints in the cartridge housing, that the fifth gear 92 and the sixth gear 94 may be combined so that there is only one gear meshed with and transferring energy from the fourth gear 90 to the seventh gear 96.

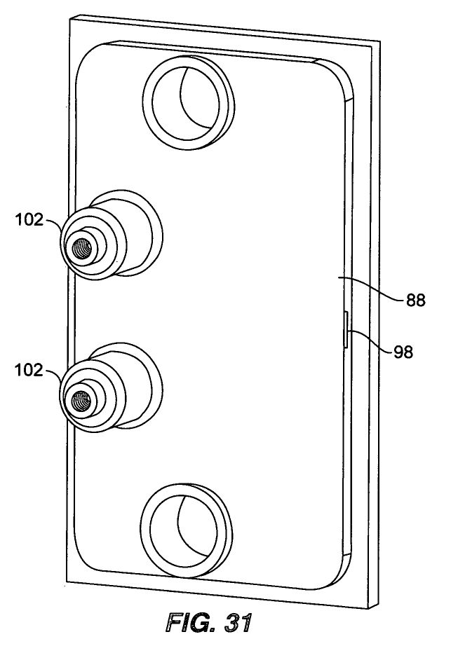

FIG. 31 illustrates a perspective view of the insert 88. The insert 88 includes a plurality of tabs 98 so that the insert 88 may be inserted into a side opening located in the frame 84. The opening is shown as item 100 in FIG. 30. As shown in FIG. 31, the insert 88 includes gear hubs 102 so that idler gears, such as gears 92 and 94 may be located on the gear hubs 102. The gear hubs 102 include fastener holes so that washers and fasteners may secure the gears to the gear hubs 102 while still allowing the gears 92 and 94 to freely rotate as necessary.

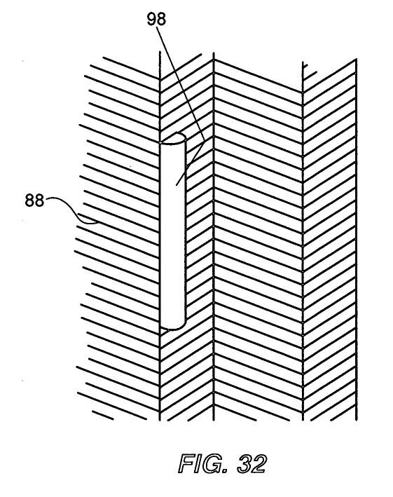

FIG. 32 is a close-up view of tab 98 of insert 88. Insert 88 may be made of a lightweight injection molded plastic or nylon, but of course any material may be utilized, such as aluminum or brass, by way of example.

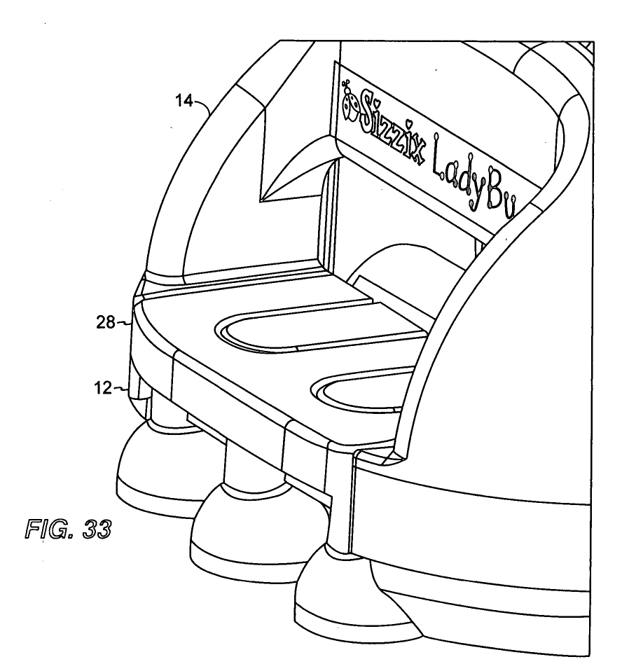

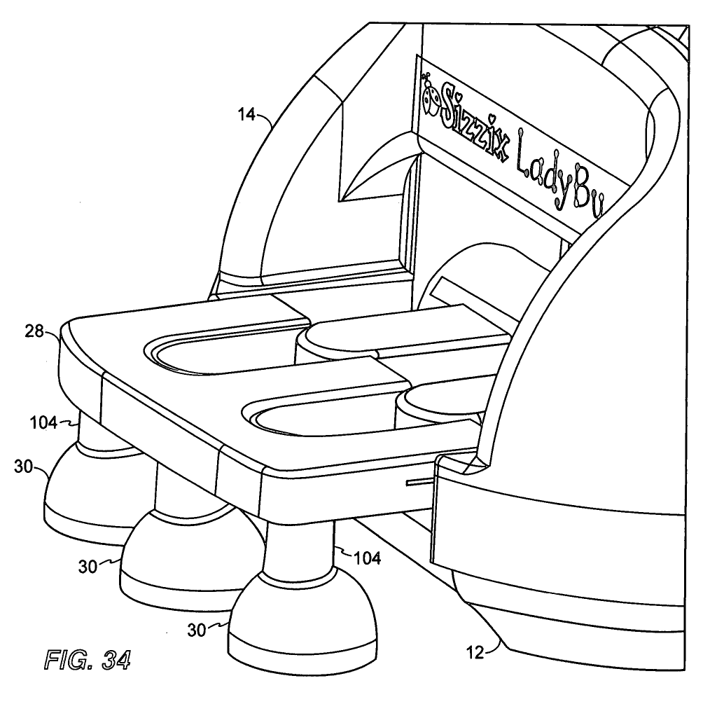

FIG. 33 is a close-up perspective view of the extendable surface 28 shown in a collapsed position relative to the shell 14 and the base 12. FIG. 34 illustrates the extendable surface 28 in an extended position relative to the shell 14 and the base 12. In FIG. 34, the feet 30 are shown supporting the extendable surface 28 with columns shown extending from the feet 30 to the bottom surface of the extendable surface 28.

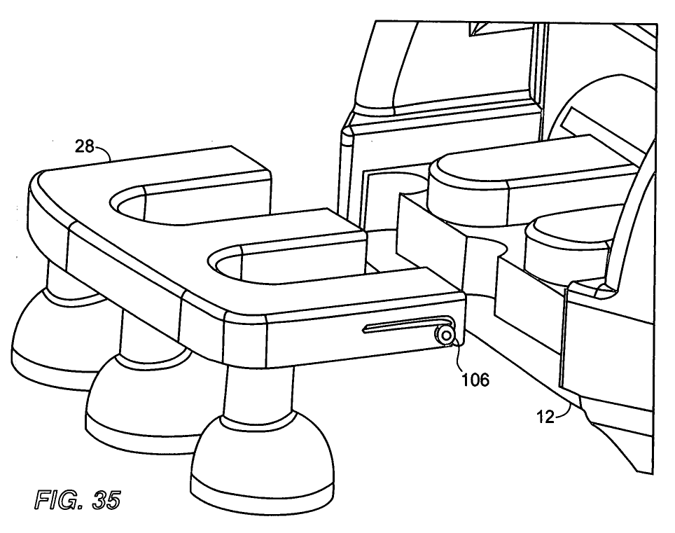

FIG. 35 shows the extendable surface 28 removed from the base portion 12. This is accomplished by disconnecting the extendable surface 28 from the base portion 12 by depressing opposing spring locks 106 (only one spring lock 106 is shown in FIG. 35). This allows the extendable surface 28 to be replaced, if necessary during use of the press 10. This further allows for ease of manufacturing of connecting the extendable surface 28 onto the base 12. Likewise, the opposite extendable surface 34 is releasably connected to the base 12 by similar spring locks 106. (Not shown.)

FIG. 36 illustrates a different gear configuration at the crank handle end, and further illustrates a full view of the frame 84 as assembled with two opposing portions as described above. In the configuration shown in FIG. 36, the first gear 76 rotates a first roller gear 108 which is coupled to the first roller.

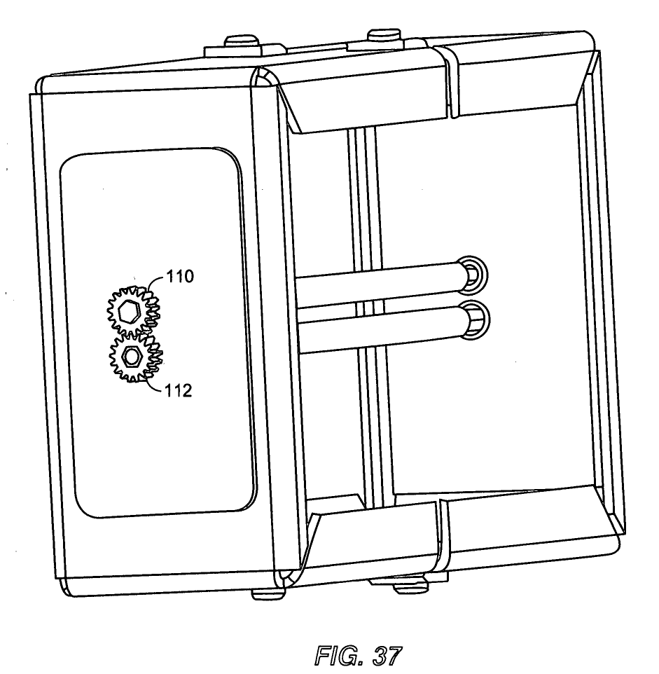

Further, in the embodiment shown in FIG. 36, the opposing side, or the side opposite of the crank handle, utilizes a second side top roller gear 110 and a second side lower roller gear 112. Therefore, the gear ratio in the embodiment shown in FIGS. 36 and 37 may be a one-to-one ratio. The ratios in the previous embodiment may include a three-to-one ratio, with the roller rotating three times for each rotation of the crank. Other gearing ratios may include a five-to-one ratio for chemical etched dies, or a one-to-one ratio for crimping, texturing, or embossing, since only approximately 10 pounds of pressure are needed for crimping and approximately four pounds of torque needed in terms of rotating the handle.

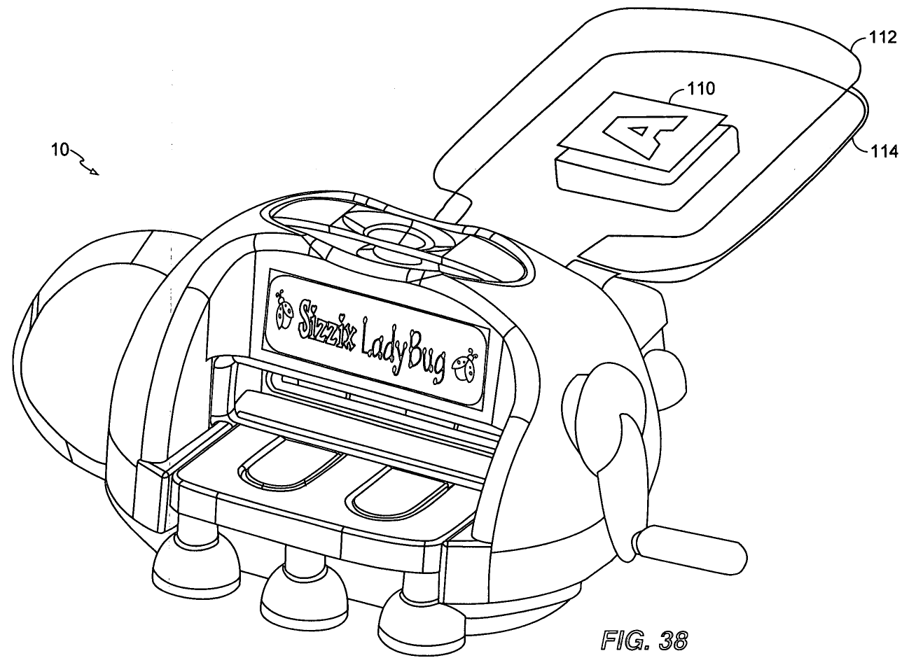

FIG. 38 illustrates the press 10 according to the present disclosure with a die 110 shown through a phantom view of a shuttle which includes an upper sheet 112 and a lower sheet 114. The sheets 112 and 114 may be made of a polycarbonate, nylon, or other polymer material which allows the transfer of force from the rollers through to the die and the sheet material to be cut from (not shown in FIG. 38). The shuttle, which comprises the die 110 and the two polymer sheets 112 and 114 are fed into the working area 38 between the rollers by feeding the shuttle into the rollers via the extendable surface areas 28 or 34. The extendable surface areas 28 or 34 can be positioned to align a bottom edge of the shuttle with the outer surface of the bottom roller. In other embodiments, the extendable surface areas 28 or 34 can be configured to align the bottom edge of the shuttle or other material passed through the press at a height that is above a top surface of the bottom roller. In still other embodiments, the extendable surface areas 28 or 34 may be positioned below the top surface or edge of the bottom roller. For example, the extendable surface areas 28 or 34 may be positioned approximately 0.030 inch below the top edge or surface of the bottom roller. The crank handle 22 is then rotated and the rollers work in cooperation with each other to feed the shuttle from one side of the press to the other side of the press, while applying pressure to the shuttle.

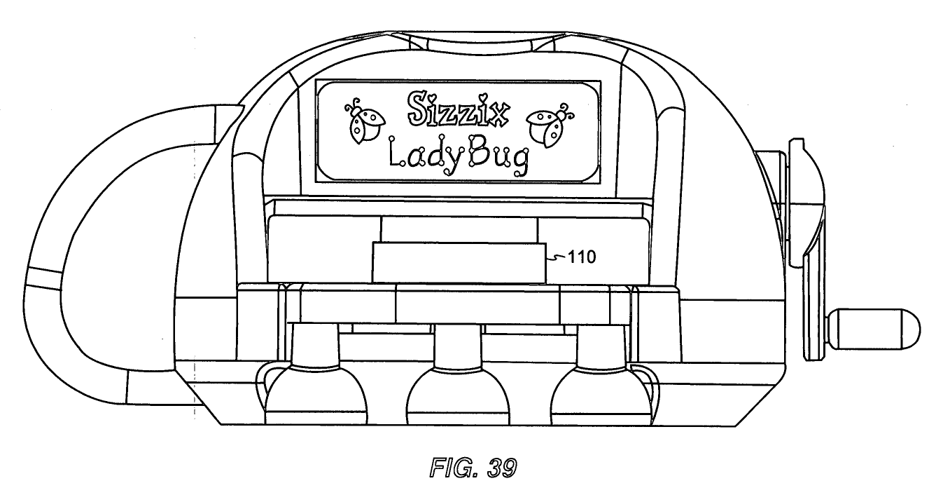

FIG. 39 illustrates a side view of the press with the die 110 located between the rollers.

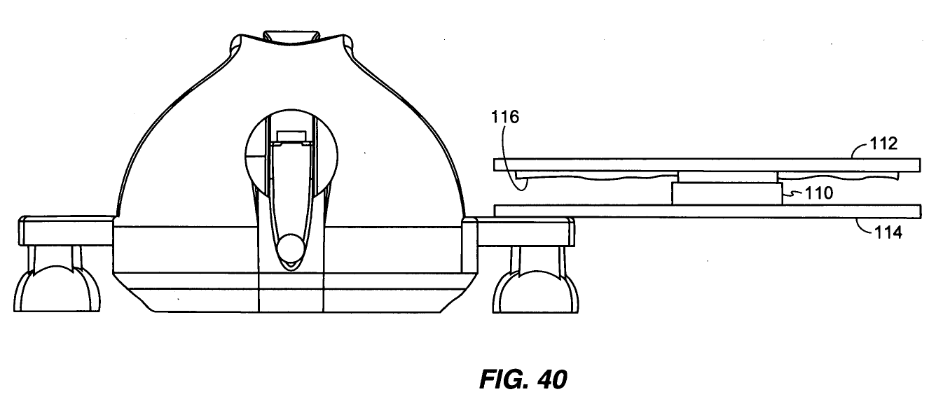

FIG. 40 illustrates a back view of the press with the die and the shuttle, or the sheets 112 and 114 off to the side of the rollers. In FIG. 40, the sheet material of which the shape is to be cut is illustrated as 116.

Although the disclosure has been described by way of example and with reference to particular embodiments thereof it is to be appreciated that improvements or modifications may be made thereto without departing from the scope and spirit of the disclosure as set out in the claims.

1. A die press comprising:
a shell having a shell opening; and
a cartridge having at least one roller and configured to be releasably coupled to the shell when inserted into the shell opening.

2. The die press of claim 1, further comprising a cartridge latch mechanism coupled to the shell and configured to retain the cartridge when inserted into the shell by at least a predetermined distance.

3. The die press of claim 2, wherein the cartridge latch comprises:
a button; and
a tang coupled to the button and configured to restrict removal of the cartridge when the cartridge is inserted into the shell and allow the cartridge to be removed from the shell when the button is depressed.

4. The die press of claim 2, wherein the cartridge latch comprises:
a tang; and
a spring configured to exert a force against the tang to capture the cartridge in the shell when the cartridge is inserted into the shell.

5. The die press of claim 1, further comprising a crank handle coupled to the shell and having an extension configured to couple with the cartridge when the cartridge is inserted into the shell opening.

6. The die press of claim 5, wherein the cartridge comprises a connector configured to couple with the extension and configured to transfer a rotational force from the crank handle to the at least one roller.

7. The die press of claim 5, wherein the crank handle comprises a hinge to allow a portion of the crank handle to be rotated inward toward the shell.

8. The die press of claim 1, wherein the shell further comprises a base substantially aligned with a working area of the cartridge.

9. The die press of claim 8, wherein the shell further comprises an extendable surface coupled to the base and configured to extend from the base.

10. The die press of claim 9, wherein the extendable surface comprises at least one foot located on an underside of the extendable surface for supporting the die press.

11. The die press housing of claim 9, wherein the extendable surface is positioned with a top surface beneath a top edge of a lower roller of the at least one roller.

12. The die press of claim 1, wherein the cartridge comprises:
a first roller configured to rotate along a first axis; and
a second roller configured to rotate along a second axis substantially parallel to the first axis.

13. The die press of claim 1, wherein the cartridge comprises:
a first roller having theron a male die; and
a second roller having thereon a female die so as to emboss a pattern on a material passed through the first and second rollers.

14. A die press housing comprising:
a shell having a shell opening configured to receive a cartridge having at least one roller; and
a cartridge latch mechanism coupled to the shell and configured to retain the cartridge when the cartridge is inserted into the shell by at least a predetermined distance.

15. The die press housing of claim 14, further comprising a crank handle coupled to the shell and configured to receive a rotational force and transfer the rotational force to the at least one roller of the cartridge when the cartridge is inserted into the shell.

16. The die press housing of claim 14, wherein the shell further comprises a base portion substantially aligned with an axis of the at least one roller.

17. The die press housing of claim 16, further comprising at least one extendable surface coupled to the base and configured to extend from the base.

18. The die press housing of claim 17, wherein the at least one extendable surface is positioned with a top surface at a height that is beneath a lower roller of the at least one roller.

19. A removable cartridge for a die press; the cartridge comprising:
a first roller configured to receive a rotational force when the cartridge is inserted into a die press housing; and
a second roller coupled to the first roller and configured to rotate in an opposite direction of the first roller.

20. The cartridge of claim 19, further comprising a connector coupled to the first roller and configured to receive the rotational force.

21. The cartridge of claim 19, further comprising:
a first gear coupled to the first roller; and
a second gear coupled to the second roller and the first gear to rotate the second roller in synchronization with the first roller.

22. The cartridge of claim 19, wherein the first roller includes a male die thereon and the second roller includes a complementary female die thereon.

23. The cartridge of claim 19, wherein the first roller includes a male crimping die and the second roller includes a complementary female crimping die and configured to crimp a material passed through the rollers.

24. A method of operating a die press, the method comprising:
providing a die press housing having a cartridge opening;
selecting a cartridge for coupling with the die press housing, the cartridge having at least one roller;
inserting the cartridge into the cartridge opening to engage the cartridge with the die press housing; and
providing a rotational force to a portion coupled to the die press housing to transfer a corresponding rotational force to the at least one roller.
